(19) United States
(12) Patent Application Publication
(10) Pub. No.: US 2009/0138911 A1
(43) Pub. Date: May 28, 2009

(54) VIDEO BROADCASTING SYSTEM

(76) Inventors: Diane Garza Flemming, Pflugerville, TX (US); Ghadir Robert Gholami, Austin, TX (US); Octavian Florin Herescu, Austin, TX (US); William A. Maron, Austin, TX (US); Mysore Sathyanarayana Srinivas, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/945,737

(22) Filed: Nov. 27, 2007

(51) Int. Cl. H04N 7/173

(52) U.S. Cl. 725/39; 725/105

(57) ABSTRACT

A method, medium and implementing processing system, are provided in which premium programming content is included in a standard program broadcasting system. The added content is stored at a user site for subsequent viewing at the user's convenience. The receipt and storing of the premium programming is accomplished without interfering with the receipt of standard broadcast signals. The premium programming, in one example, is transmitted and incrementally received and stored on a user's system even while standard programming is received and viewed by the user. When all of the broadcast increments of a premium program have been received and the premium program has been stored in the user's system, a signal is provided to the user to indicate the availability of the premium program for selective viewing by the user.

### FIELD OF THE INVENTION

The present invention relates generally to information processing systems and more particularly to a methodology and implementation for adding content to video broadcasting.

### BACKGROUND OF THE INVENTION

Standard television waves are transmitted via radio signals to televisions with antennae. With current standard broadcast systems, there has been no development toward a premium programming pay-per-view (PPV) system which is now available only to cable subscribers. However, many TV viewers do not subscribe to cable systems and therefore cannot access PPV programming. If available, many non-cable television viewers, although not willing or able to subscribe to a cable system, would use a PPV function in a broadcast system to enjoy premium programming. Such a system would provide many additional viewing options to broadcast TV viewers and also provide an additional revenue source for broadcasting companies.

Thus there is a need for an improved methodology and implementing system which enables transmission of premium programming in addition to standard programming over currently existing broadcast systems.

### SUMMARY OF THE INVENTION

A method, medium and implementing processing system are provided in which premium programming content is included in a standard program broadcasting system. The added content is stored at a user site for subsequent viewing at the user's convenience. The receipt and storing of the premium programming is accomplished without interfering with the receipt of standard broadcast signals. The premium programming, in one example, is transmitted and incrementally received and stored on a user's system even while standard programming is received and viewed by the user. When all of the broadcast increments of a premium program have been received and the premium program has been stored in the user's system, a signal is provided to the user to indicate the availability of the premium program for selective viewing by the user.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a television broadcast system in which the present invention, may be implemented;

FIG. 2 is a simplified block diagram shoving several of the major components of the set-top converter box shown in FIG. 1;

FIG. 3 is a schematic diagram illustrating an exemplary storage function which may be implemented in connection with the present invention;

FIG. 4 is a flow chart illustrating an operational sequence of an exemplary embodiment of the present invention; and

FIG. 5 is a continuation of the FIG. 4 flow chart.

### DETAILED DESCRIPTION

The various methods discussed herein may be implemented, within a video broadcast system which may include, inter alia, transmission encoding and user de-coding processing systems, a transmission and receiving system, and a user system which may include, inter alia, a user processing device, memory, memory controller and storage and display means. Since the individual components of a transmission and receiving system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a television broadcasting and receiving system, it is understood that the principles of the invention may be implemented in any of many available and future broadcast and communication devices and systems, including but not limited to personal reception devices, hand-held personal computer devices and cell phone and other wireless communication devices.

In current TV broadcast systems, programming is transmitted from a broadcast station to a user's antenna in frames of information. A single frame contains 525 lines, of which a significant number are used to broadcast a picture. There are, however, additional lines which contain no information and which are therefore not used. The unused capacity is still broadcast but contains no data. In accordance with the present disclosure, local television stations are enabled to use this currently unused capacity to broadcast additional content which may be made available for example, to subscribers who have paid for a subscription to the premium programming service.

Using the un-used frame space for example, a TV station can broadcast additional content in each frame. The additional content or fragments of information, in itself, would not be sufficient for the standard TV to reconstruct a picture. Therefore a set-top box, including, inter alia, a receiving means, a storage device and a memory controller is provided that allows the bits and fragments of premium content to be downloaded, over a period of time, to the box storage. When all of the fragments of content for a premium program have been received, the box is enabled to provide a signal to the consumer, for example with a light or an LED, that the complete content is available. For the purposes of this disclosure, a movie download is used as a download example, but the content could be anything (learning material, news, commercials, un-syndicated shows). The consumer can then watch the content, similarly to the playing a DVD, at the user's convenience, as often as the user wishes.

If, for example, a TV station has contracted to provide a new movie every month, the consumer can then watch the movie as often as he likes. At the start of a new time period, which may for example be a week or a month, the TV station will begin downloading the next movie or premium program. It will take a certain amount of time, several hours, to download the entire content, and the consumer will be notified when the download is complete. The TV station is enabled to continuously broadcast the content so that new account holders can receive the current month's movie or other premium program within a certain amount of time. The set-top boxes which already have a full copy of the premium content (that is, existing account holders) will not try to store the redundant images. In another example, a TV station would broadcast more than one movie each month and have a storage box on the consumer's side that is large enough to store two, or even more movies. Also, if several TV stations collaborate, the box could be extended to store movies from different channels on the same box, using the same monthly-update scheme.

The broadcast will include, for example, at least a “box key”, a movie identifier and a movie fragment identifier. The box key is a security mechanism that allows the TV station to control who can save the content. A system user receives the numerical key (email or included in a billing statement) to program the user's box to receive and save the current month's premium programming transmission. The movie identifier includes information as to whether the transmission has been updated. If the movie identifier in the transmission is different from the movie identifier of the movie currently resident in its memory, then the box will try to store it. Otherwise, it is a signal that the content has not been updated and the box will not try to store it. The fragment identifier indicates which fragment is being sent so the box can process the fragments to compose a complete movie or other premium program. An example is a fragment identifier that says the current fragment is item 234 out of 12,345 items. If a subscription is started in the middle of a transmission, the box will notice that the movie identifier is different from the one in memory (presumable there isn't a movie identifier in memory) and will begin storing the content. When the TV station begins re-broadcasting the same content from the beginning, the box will store those fragments in their appropriate place. When all fragments have been received the box will light up (or some other method to indicate a complete reception and storage) and the movie is then available for playback. An alternate method for those who start their subscription in the middle of a transmission is that the box will simply wait until it sees the first fragment of a transmission to begin storing the movie.

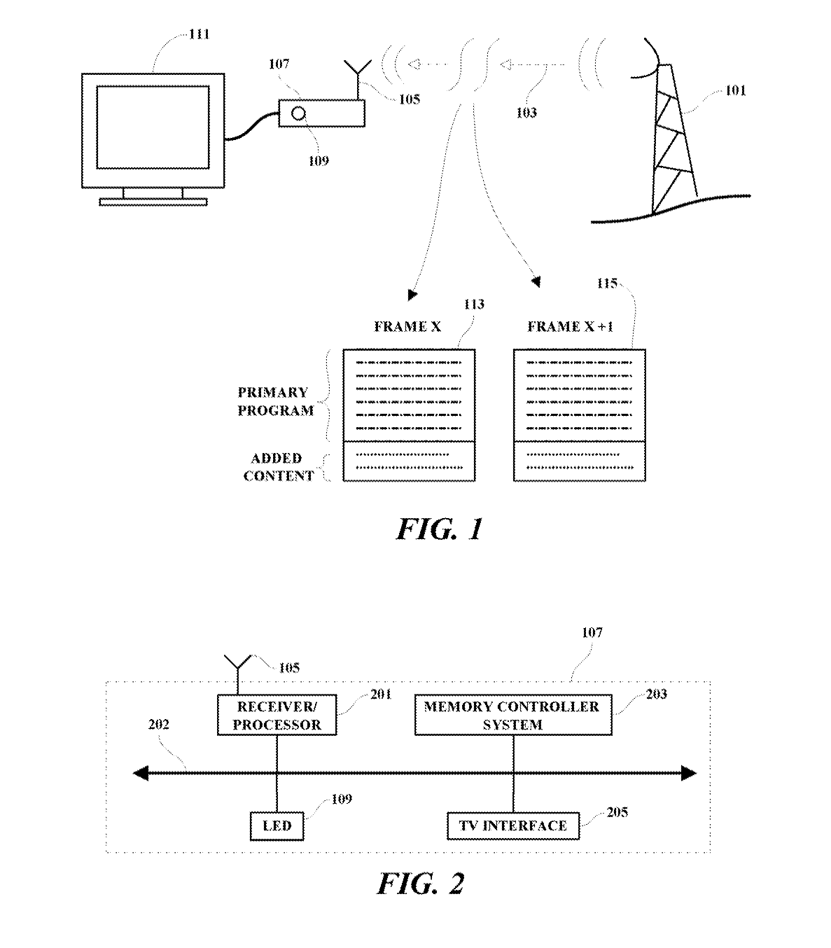

With specific reference to the drawings, FIG. 1 shows a transmission tower 101 for transmitting television signals 103 from a broadcast site to an antenna 105 of a user's set-top box 107. The set-top box 107 in the example includes an LED indicating light 109. The set-top box is also connected to a television set 111 for displaying received television programing to a user. The broadcast television signals 103 are transmitted as frames of information including exemplary Frame X 113 and Frame X+1 115. As shown, each frame contains lines of a primary broadcast program and also, in previously unused lines, the frames include added content which in the present example includes premium programming or subscription programming. Thus, along with the standard broadcasting from a TV station 101, there is included premium programming information contained with the same frame transmissions.

FIG. 2 shows several of the major components of the set-top box 107 shown in FIG. 1. As shown, set-top box includes, inter alia, a receiver/processor circuit 201 which couples the antenna 105 to a system bus 202. Also coupled to the system bus 202 is the LED 109. The system bus 202 is connected to the television set 111 through a TV interface 205. Also shown coupled to the system bus 202 is a memory controller system 203.

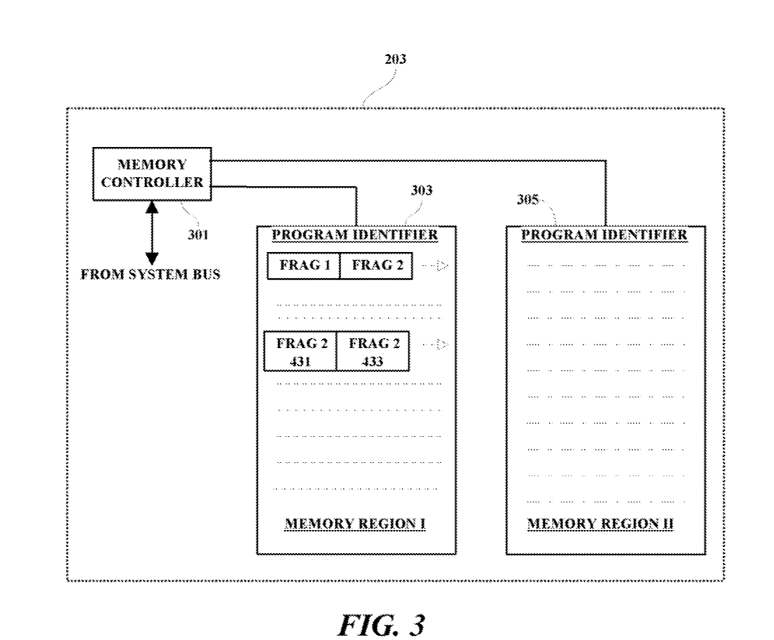

FIG. 3 illustrates a storage methodology for storing fragments of premium programming information within the memory controller system 203. The memory controller system 203 includes a memory controller 301 which is coupled to the system bus 202. As hereinbefore noted, each broadcast frame contains both primary TV broadcast information in a first portion of the frame and also premium programming information in a second portion of the broadcast frame. The primary TV broadcast information is identified and sent to the TV set 111 in a normal manner and the premium programming information is diverted and incrementally sent to the memory controller system for storage. In the example illustrated, two Memory Regions 303 and 305 are illustrated and arranged to store two different premium programs. As premium program fragments are received in each broadcast frame, they are identified by a program identifier and fragment identifier, and are stored in the appropriate storage location in one of the Memory Regions 303 or 305.

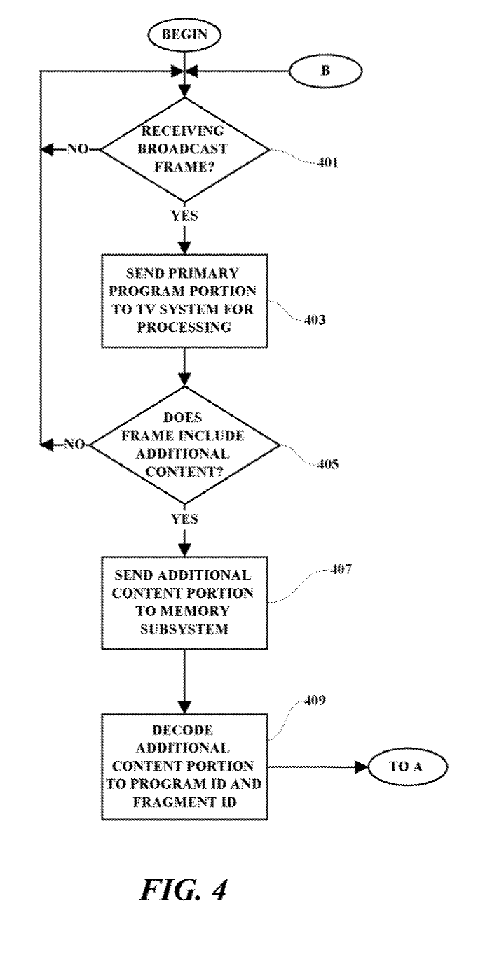

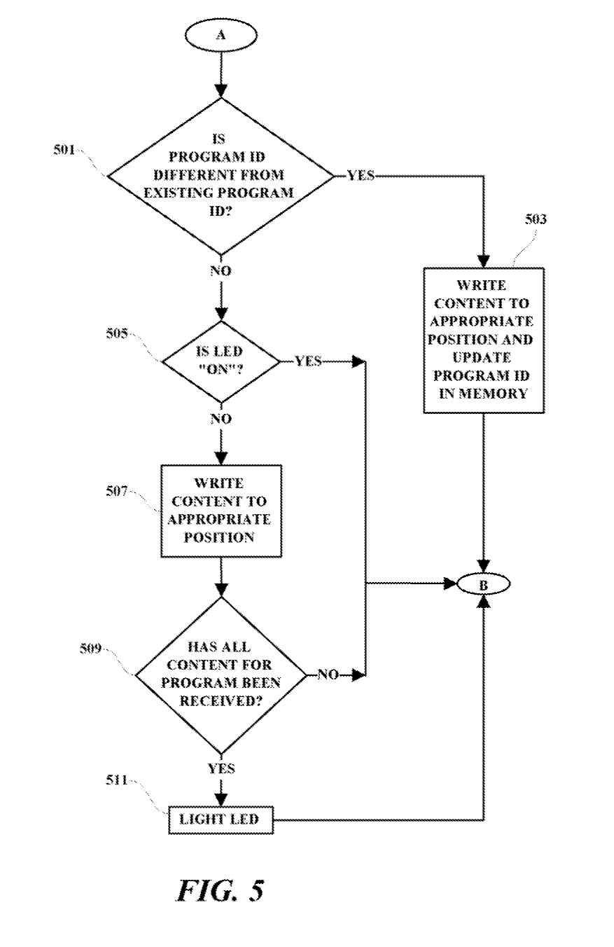

In an exemplary operation, as shown in FIG. 4, when the system begins to operate, a check is made 401 to determine if broadcast frames are being received. It should be noted that broadcast frames, including premium programming data, may be received even though the TV has not yet been turned ON and the premium programming information will still be received and stored. If broadcast frames are being received, the primary program portion of the frames is sent to the TV system 403 for normal processing and display and a check is made 405 to determine if the received frame includes additional content or premium programming information. If additional premium program frame content is detected 405 then the additional content is sent 407 to the memory subsystem 203 for processing. The Premium programming content is then decoded to determine Program ID and Fragment ID 409. As the processing continues as shown in FIG. 5, if the Program ID is different from existing Program ID 501, then the received content is written to an appropriate position in memory, the Program is updated 503 and the process returns to await receipt of the next frame 401. If the received Program ID is not different from the existing Program ID 501, then a check is made 505 to determine if the program completion LED is ON. If all fragments of a premium program had been received and stored and the program completion LED had been turned ON, then the processing returns to await receipt of the next frame 401. If, however, the LED 109 is not ON 505, then the received content is written 507 to the appropriate position in memory. If all of the content for a premium program has not yet been received 509 then the processing returns to await receipt of the next frame 401. After all of the premium program content has been received for a premium program 509, the LED 109 is turned ON 511 before the processing returns to await receipt of the next frame 401. In the example, when the LED 109 is turned ON, it indicates that a completed premium program has been received and stored as is available for selective access and viewing by the user. Standard player applications (not shown) may be implemented to access and play the premium program which has been received in the background as part of a IV broadcast and stored in the user's memory system.

The method and apparatus of the present invention has been described in connection with a preferred embodiment as disclosed herein. The disclosed methodology may be implemented in a wide range of sequences, and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for transmitting an added content file together with a transmission of primary television (TV) signals being broadcast from a broadcast source, said primary TV signals being transmitted in a series of frames of information wherein said frames include a first group of lines containing said primary TV signals, and a second group of lines, said second group of lines being unused in said transmission of said primary TV signals, said method comprising:
dividing said added content file into file fragments;
transmitting said primary TV signals in said first group of lines in each of said series of frames of information, said primary TV signals being configured to cause a presentation of primary TV programming on a TV set receiving said series of frames; and
transmitting sequential ones said file fragments in said second grouping of lines in each of said series of frames of information, said file fragments being configured to be assembled at a receiver site to re-create said added content file at said receiver site.

2. The method as set forth in claim 1 and further including:
receiving said series of frames at a receiver site;
separating said primary TV signals from said file fragments;
sending said primary TV signals to a TV set at said receiver site; and
saving said file fragments to memory at said receiver site.

3. The method as set forth in claim 2 and further including;
determining when all of said file fragments of said added content file have been received; and
providing a perceptible indicium to a user at said receiver site when all of said file fragments of said added content file have been received at said receiver site.

4. The method as set forth in claim 2 and further including enabling a user to play said added content file at said receiver site after all of said file fragments of said added content file have been received at said receiver site.

5. The method as set forth in claim 3 and further including enabling a user to play said added content file at said receiver site after all of said file fragments of said added content file have been received at said receiver site.

6. The method as set forth in claim 1 and further including:
providing a plurality of said added content files;
assigning a unique identifier for each of said plurality of said added content files; and
enabling a storing of said plurality of added content files in separate memory regions of a memory located at said receiver site.

7. The method as set forth in claim 6 and further including assigning a unique identifier for each of said file fragments contained in said plurality of said added content files.

8. A medium including programming information executable for providing program signals for enabling transmitting of an added content file together with a transmission of primary television (TV) signals being broadcast from a broadcast source, said primary TV signals being transmitted in a series of frames of information wherein said frames include a first group of lines containing said primary TV signals, and a second group of lines, said second group of lines being unused in said transmission of said primary TV signals, said program signals being effective for:
dividing said added content file into file fragments;
enabling a transmitting said primary TV signals in said first group of lines in each of said series of frames of information, said primary TV signals being configured to cause a presentation of primary TV programming on a TV set receiving said series of frames; and
enabling a transmitting of sequential ones said file fragments in said second grouping of lines in each of said series of frames of information, said file fragments being configured to be assembled at a receiver site to re-create said added content file at said receiver site.

9. A medium including programming information executable for providing program signals for enabling receiving of an added content file together with a receipt of primary television (TV) signals being broadcast from a broadcast source, said added content file being divided into file fragments, said primary TV signals being transmitted in a series of frames of information wherein said frames include a first group of lines containing said primary TV signals, and a second group of lines, said second group of lines being unused in said transmission of said primary TV signals, said program signals being effective for:
enabling a receiving said series of frames at a receiver site;
separating said primary TV signals from said file fragments;
sending said primary TV signals to a TV set at said receiver site; and
saving said file fragments to memory at said receiver site.

10. The medium as set forth in claim 9 wherein said program signals are further effective for:
enabling a determining when all of said file fragments of said added content file have been received; and
providing a perceptible indicium to a user at said receiver site when all of said file fragments of said added content file have been received at said receiver site.

11. The medium as set forth in claim 9 wherein said program signals are further effective for enabling a user to play said added content file at said receiver site after all of said file fragments of said added content file have been received at said receiver site.

12. The medium as set forth in claim 10 wherein said program signals are further effective for enabling a user to play said added content file at said receiver site after all of said file fragments of said added content file have been received at said receiver site.

13. The medium as set forth in claim 9 wherein each of said added content files includes a unique identifier, said program signals being further effective for:
enabling a receiving of a plurality of said added content files; and
enabling a storing of said plurality of added content files in separate memory regions of a memory located at said receiver site.

14. The medium as set forth in claim 13 wherein each of said file fragments includes a unique identifier.

15. A receiver unit for receiving of an added content file being transmitted together with primary television (TV) signals being broadcast from a broadcast source, said added content file being divided into file fragments, said primary TV signals being transmitted in a series of frames of information wherein said frames include a first group of lines containing said primary TV signals, and a second group of lines, said second group of lines being unused in said transmission of said primary TV signals, said receiver unit including:
means for enabling a receiving said series of frames at a receiver site;
means for separating said primary TV signals from said file fragments;
means for sending said primary TV signals to a TV set at said receiver site; and
means for saving said file fragments to memory at said receiver site.

16. The receiver unit as set forth in claim 15 and further including:
means for enabling a determining when all of said file fragments of said added content file have been received; and
means for providing a perceptible indicium to a user at said receiver site when all of said file fragments of said added content file have been received at said receiver site.

17. The receiver unit as set forth in claim 15 and further including:
means for enabling a user to play said added content file at said receiver site after all of said file fragments of said added content file nave been received at said receiver site.

18. The receiver unit as set forth in claim 16 and further including:
means for enabling a user to play said added content file at said receiver site after all of said file fragments of said added content file have been received at said receiver site.

19. The receiver unit as set forth in claim 15 wherein each of said added content files includes a unique identifier, said receiver unit further including:
means for enabling a receiving of a plurality of said added content files; and
means for enabling a storing of said plurality of added content files in separate memory regions of a memory located at said receiver site.
